(19) United States
(12) Patent Application Publication
(10) Pub. No.: US 2025/0100086 A1
(43) Pub. Date: Mar. 27, 2025

(54) METHOD FOR USING LASER DEVICE AND PRODUCTION LINE THEREOF

(71) Applicant: HYMSON LASER TECHNOLOGY GROUP CO., LTD., Shenzhen (CN)

(72) Inventors: Qirui HE, Shenzhen (CN); Yuhuai YANG, Shenzhen (CN); Jianye MIAO, Shenzhen (CN); Taiqing MA, Shenzhen (CN); Xue ZHANG, Shenzhen (CN); Shuai DENG, Shenzhen (CN); Deji GU, Shenzhen (CN); Guanglin YE, Shenzhen (CN); Zhiming CHEN, Shenzhen (CN)

(73) Assignee: HYMSON LASER TECHNOLOGY GROUP CO., LTD., Shenzhen (CN)

(21) Appl. No.: 18/794,891

(22) Filed: Aug. 5, 2024

Related U.S. Application Data
(63) Continuation of application No. PCT/CN2024/090437, filed on Apr. 28, 2024.

(30) Foreign Application Priority Data
Sep. 21, 2023 (CN) 202311237567.6

(51) Int. Cl. B23K 26/70; B23K 26/08; B23K 26/082; B23K 101/36

(52) U.S. Cl. CPC B23K 26/703; B23K 26/707; B23K 26/082; B23K 26/083; B23K 2101/36

(57) ABSTRACT

A method for using a laser device includes: dividing laser devices into a first laser group and a second laser group, and turning on the laser device in the first laser group and processing the pole sheet; when any temperature value of a galvanometer and a field lens of the laser device in the first laser group reaches a set value, turning off the laser device in the first laser group, and turning on the laser device in the second laser group to continue processing the pole sheet; when any temperature value of the galvanometer and field lens of the laser device in the second laser group reaches the set value, turning off the laser device in the second laser group, and turning on the laser device in the first laser group to continue processing the pole sheet.

### CROSS-REFERENCE TO RELATED APPLICATIONS

This application is a continuation application of International Application No. PCT/CN2024/090437, filed on Apr. 28, 2024, which claims priority to Chinese Patent Application No. 202311237567.6, filed on Sep. 21, 2023. The disclosures of the above-mentioned applications are incorporated herein by reference in their entireties.

### TECHNICAL FIELD

The present application relates to the technical field of cell processing equipment, and in particular to a method for using a laser device and a production line thereof.

### BACKGROUND

In the related art, when processing the pole sheet, the efficiency of charging and discharging of the battery cell can be improved by slotting the pole sheet with a laser device (the pole sheet is wound or stacked to form a cell).

In order to ensure that the production efficiency on the production line meets the demand, the laser device will run for a long time to slot the pole sheet. However, after the laser passes through the galvanometer and field lens for a long time, the temperature of the galvanometer and field lens will be high, resulting in problems such as temperature drift, larger spot and smaller energy of the galvanometer and field lens. In this way, the quality of the slotting of the laser device will not meet the standards. In order to ensure the quality, the laser device will be turned off for a period of time to reduce the temperature of the galvanometer and field lens. However, after the laser device is turned off, the problem of low production efficiency will occur.

### SUMMARY

The main purpose of the present application is to provide a method for using a laser device, aiming to solve at least one of the shortcomings existing in the related art. In view of this, the present application provides a method for using a laser device, which can ensure that the laser device has a high quality of slotting the pole sheet, and can also increase the production efficiency of the production line.

According to a first aspect, the present application provides a method for using the laser device, applied to a production line, the production line including a plurality of laser devices, and the laser device being configured to process a pole sheet; the method including following steps:
S1, dividing the plurality of laser devices into a first laser group and a second laser group, and turning on the laser device in the first laser group and processing the pole sheet;
S2, in response to that any temperature value of a galvanometer and a field lens of the laser device in the first laser group reaches a set value, turning off the laser device in the first laser group, and turning on the laser device in the second laser group to continue processing the pole sheet;
S3, in response to that any temperature value of the galvanometer and field lens of the laser device in the second laser group reaches the set value, turning off the laser device in the second laser group, and turning on the laser device in the first laser group to continue processing the pole sheet; and
S4, repeating steps S2 to S3.

The method for using the laser device according to the embodiment of the present application has at least the following beneficial effects: the first laser group includes a plurality of laser devices, the second laser group includes a plurality of laser devices. The pole sheet is processed by the laser device in the first laser group, such as slotting the pole sheet. Afterwards, in response to that any temperature value of the galvanometer or field lens of the laser device in the first laser group reaches a set value, the laser device in the first laser group is turned off, which can protect the galvanometer and field lens of the laser device in the first laser group and prevent the galvanometer and field lens from reducing the processing quality of the pole sheet. At the same time, the laser device in the second laser group is turned on to continue processing the pole sheet, which can continuously process the pole sheet and improve production efficiency. In response to that any temperature value of the galvanometer or field lens of the laser device in the second laser group reaches the set value, the laser device in the second laser group is turned off, which can protect the galvanometer and field lens of the laser device in the second laser group and prevent the galvanometer and field lens from reducing the processing quality of the pole sheet. At the same time, the laser device in the first laser group is turned on to continue processing the pole sheet, which can process the pole sheet uninterruptedly to improve production efficiency. In this way, the pole sheet can be processed uninterruptedly by switching the laser devices in the first laser group and the second laser group, which can make the production line have a higher production efficiency. The method for using the laser device can ensure that the laser device has a high quality of slotting the pole sheet, and can also make the production line have a higher production efficiency.

In an embodiment, in step S2, the method further includes the following step: after turning off the laser device of the first laser group, cooling down the galvanometer and the field lens of the laser device in the first laser group.

In an embodiment, the galvanometer and the field lens are cooled by water cooling or air cooling.

In an embodiment, in step S3, the method further includes the following step: after turning off the laser device of the second laser group, cooling down the galvanometer and the field lens of the laser device in the second laser group.

In an embodiment, in step S1, when the laser device in the first laser group is turned on and configured to process the pole sheet, the galvanometer and the field lens of the laser device in the first laser group are cooled down at the same time.

In an embodiment, in step S2, when the laser device in the second laser group is turned on and configured to process the pole sheet, the galvanometer and the field lens of the laser device in the second laser group are cooled down at the same time.

According to a second aspect, the present application provides a production line, includes: a first laser group, a second laser group, a temperature sensor and a controller.

In an embodiment, the first laser group and the second laser group each include a plurality of laser devices, and the laser devices are configured to process a pole sheet.

In an embodiment, the temperature sensor is configured to detect a temperature value of a galvanometer and a field lens in the laser device.

In an embodiment, the controller is connected to the first laser group, the second laser group and the temperature sensor, and the controller is configured to receive and send signals; the controller is configured to: in response to detecting that any temperature value of the galvanometer and the field lens in the first laser group reaches a set value, turn off the laser device in the first laser group and turn on the laser device in the second laser group; and in response to detecting that any temperature value of the galvanometer and the field lens in the second laser group reaches the set value, turn off the laser device in the second laser group and turning on the laser device in the first laser group.

The production line according to the embodiment of the present application has at least the following beneficial effects: the first laser group includes a plurality of laser devices, the second laser group includes a plurality of laser devices. The pole sheet is processed by the laser device in the first laser group, such as slotting the pole sheet. Then the temperature value of the galvanometer and the field lens of the laser device in the first laser group is detected by the temperature sensor, when the temperature sensor detects that any temperature value of the galvanometer or the field lens of the laser device in the first laser group reaches the set value, the temperature sensor sends a signal to the controller. The controller is configured to turn off the laser device in the first laser group, which can protect the galvanometer and the field lens of the laser device in the first laser group and prevent the galvanometer and the field lens from reducing the processing quality of the pole sheet. At the same time the controller is configured to turn on the laser in the second laser group to continue processing the pole sheet, which can process the pole sheet uninterruptedly and improve production efficiency. When the temperature sensor detects that any temperature value of the galvanometer or field lens of the laser device in the second laser group reaches the set value, the temperature sensor sends a signal to the controller. The controller is configured to turn off the laser device in the second laser group, which can protect the galvanometer and field lens of the laser device in the second laser group, and prevent the galvanometer and field lens from reducing the processing quality of the pole sheet. At the same time, the controller is configured to turn on the laser device in the first laser group to continue processing the pole sheet, which can process the pole sheet uninterruptedly and improve production efficiency. In this way, the pole sheet can be processed uninterruptedly by switching the laser device in the first laser group and the second laser group, which can make the production line have a higher production efficiency. The method for using the laser device can ensure that the laser device has a high quality of slotting the pole sheet, and can also make the production line have a high production efficiency.

In an embodiment, the laser device includes a first cooling member, the first cooling member is thermally connected to the galvanometer; the first cooling member is provided with a first cooling channel, and the first cooling channel is configured for the flow of cooling medium.

In an embodiment, the laser device includes a second cooling member, the second cooling member is thermally connected to the galvanometer; the second cooling member is provided with a second cooling channel, and the second cooling channel is configured for the flow of cooling medium.

In an embodiment, the production line further includes a conveying apparatus, the conveying apparatus is configured to convey the pole sheet, and the laser device in the first laser group and the laser device in the second laser group are alternately provided along the conveying direction of the pole sheet.

Additional aspects and advantages of the present application will be given in part in the description below, and in part will become apparent from the description below, or will be learned through the practice of the present application.

### BRIEF DESCRIPTION OF THE DRAWINGS

The present application is further described below with reference to the drawings and embodiments.

FIG. 1 is a flow schematic view of a method for using a laser device according to an embodiment of the present application.

FIG. 2 is a schematic view of the laser device in a production line according to an embodiment of the present application.

FIG. 3 is a schematic view of the production line according to an embodiment of the present application.

### DETAILED DESCRIPTION OF THE EMBODIMENTS

The embodiments of the present application are described in detail below, and examples of the embodiments are shown in the drawings, where the same or similar reference numerals throughout represent the same or similar elements or elements with the same or similar functions. The embodiments described below with reference to the drawings are exemplary and are only used to explain the present application, and cannot be understood as limiting the present application.

In the description of the present application, it should be understood that the directions or positional relationships indicated by the description of the orientation, such as up, down, front, back, left, right, etc., are based on the directions or positional relationships shown in the drawings, which are only for the convenience of describing the present application and simplifying the description, rather than indicating or implying that the apparatus or element referred to must have a specific orientation, be constructed and operated in a specific orientation, and therefore cannot be understood as limiting the present application.

In the description of the present application, the meaning of several is more than one, the meaning of more than two is more than two, greater than, less than, more than, etc. are understood as not including the number, and above, below, within, etc. are understood as including the number. If there is a description of the first and second, it is only for the purpose of distinguishing the technical features, and cannot be understood as indicating or implying the relative importance or implicitly indicating the number of the indicated technical features or implicitly indicating the order of the indicated technical features.

In the description of this application, unless otherwise clearly defined, the terms such as setting, installing, connecting, etc. should be understood in a broad sense, and those skilled in the art can reasonably determine the specific meaning of the above terms in this application in combination with the specific content of the technical solution.

In the description of this application, the reference terms “one embodiment”, “some embodiments”, “illustrative embodiments”, “examples”, “specific examples”, or “some examples” refer to the specific features, structures, materials or characteristics described in combination with the embodiment or example included in at least one embodiment or example of this application. In this specification, the schematic representation of the above terms does not necessarily refer to the same embodiment or example. Moreover, the specific features, structures, materials or characteristics described can be combined in any one or more embodiments or examples in a suitable manner.

In the field of new energy lithium battery technology, in order to meet the requirements of battery charging and discharging time, it is necessary to perform pole sheet scribing before cleaning the pole sheet coil to meet specific process requirements. At present, some laser scribing equipment generally only uses a single beam of laser for scribing. However, it is difficult to control the scribing depth when using a single beam of laser. When encountering a work scenario required deeper scribing, the laser energy of a single beam of laser fluctuates greatly, resulting in poor consistency in the depth of scribing. In addition, the efficiency of single beam laser scribing is low, which affects production progress.

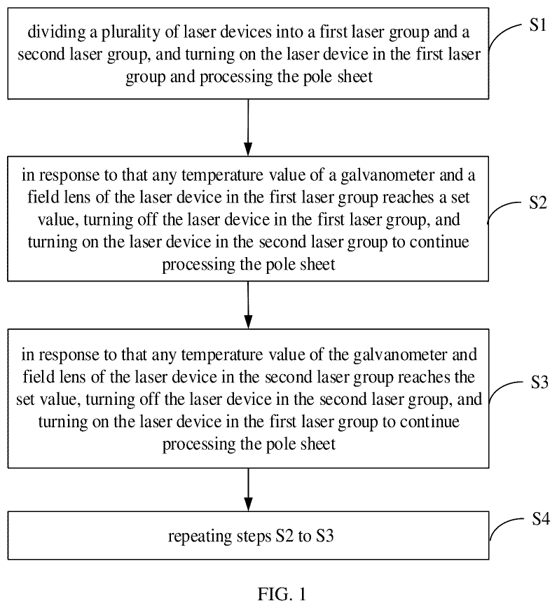

As shown in FIG. 1, in an embodiment, the present application provides a method for using a laser device, the method is applied to a production line, the production line includes a plurality of laser devices, and the laser device is configured to process a pole sheet. The method for using the laser device includes following steps:
S1, dividing the plurality of laser devices into a first laser group and a second laser group, and turning on the laser device in the first laser group and processing the pole sheet.
S2, in response to that any temperature value of a galvanometer and a field lens of the laser device in the first laser group reaches a set value, turning off the laser device in the first laser group, and turning on the laser device in the second laser group to continue processing the pole sheet.
S3, in response to that any temperature value of the galvanometer and field lens of the laser device in the second laser group reaches the set value, turning off the laser device in the second laser group, and turning on the laser device in the first laser group to continue processing the pole sheet.
S4, repeating steps S2 to S3.

The first laser group includes a plurality of laser devices 10, and the second laser group includes a plurality of laser devices 10. The pole sheet 11 is processed by the laser devices 10 in the first laser group, such as slotting the pole sheet 11. Afterwards, in response to that any temperature value of the galvanometer or field lens of the laser device 10 in the first laser group reaches a set value, the laser device 10 in the first laser group is turned off, which can protect the galvanometer and field lens of the laser device 10 in the first laser group, and prevent the galvanometer and field lens from reducing the processing quality of the pole sheet 11. At the same time, the laser device 10 in the second laser group is turned on to continue processing the pole sheet 11, which can continuously process the pole sheet 11 and improve production efficiency. In response to that any temperature value of the galvanometer or field lens of the laser device 10 in the second laser group reaches the set value, the laser device 10 in the second laser group is turned off, which can protect the galvanometer and field lens of the laser device 10 in the second laser group, and prevent the galvanometer and field lens from reducing the processing quality of the pole sheet 11, and at the same time, the laser device 10 in the first laser group is turned on to continue processing the pole sheet 11, which can continuously process the pole sheet 11 and improve production efficiency. In this way, the pole sheet 11 can be processed continuously by switching the laser devices 10 in the first laser group and the second laser group, which can make the production efficiency of the production line 9 higher. The method for using the laser device can ensure that the laser device 10 has a high slotting quality for the pole sheet 11, and can also make the production efficiency of the production line 9 higher.

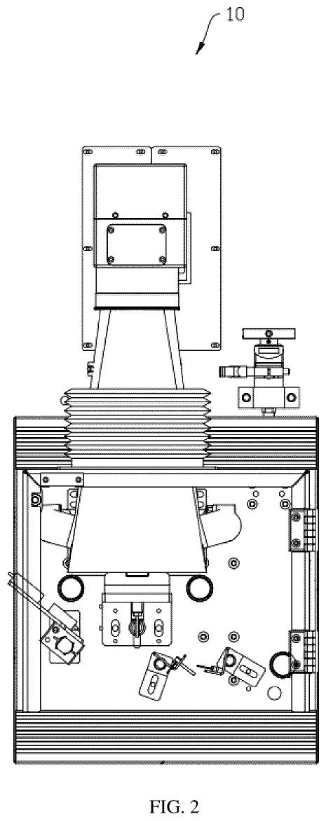

As shown in FIG. 2, which illustrates a laser device 10. The laser device 10 includes a galvanometer and a field lens. The position and size of the laser beam are controlled by adjusting the position and tilt angle of the field lens in the laser device 10. That is, the field lens mainly plays the role of focal length adjustment. The galvanometer refers to a vibrating mirror. By controlling the vibration direction and vibration frequency of the galvanometer in the laser device 10, the laser beam can be accurately hit on the object to be processed. The galvanometer mainly plays the role of scanning and positioning. The set value refers to the maximum temperature value that the galvanometer and the field lens can withstand. The maximum temperature value that the galvanometer and the field lens can withstand is 35 degrees Celsius to 50 degrees Celsius. That is, the temperature range of the set value is 35 degrees Celsius to 50 degrees Celsius. In order to avoid the product quality not meeting the standard due to the excessive temperature of the galvanometer or the field lens. In the application, when the temperature of the galvanometer is 35 degrees Celsius or the temperature of the field lens is 35 degrees Celsius, the laser device 10 needs to be stopped to prevent the product quality from not meeting the standard.

The processing of the pole sheet 11 refers to the formation of the pole sheet 11 after the foil is coated with the active material. Before the pole sheet 11 is wound or stacked to form a battery cell, the surface of the pole sheet 11 is slotted by the laser of the laser device 10. The slotting can also refer to drilling blind holes on the pole sheet 11, thereby increasing the exposed surface area of the pole sheet 11 and improving a fast charging capability of the battery. When the laser device 10 slots the pole sheet 11, the shape of the slot can be linear, such as a straight slot, and configured to extend along the length direction of the pole sheet 11. The slot can also be configured to extend along the width direction of the pole sheet 11.

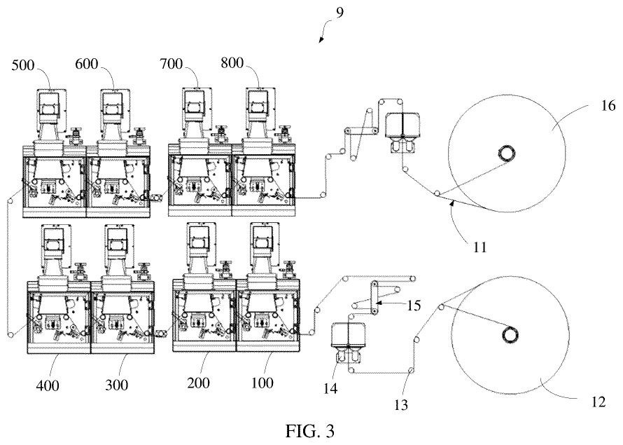

In addition, as shown in FIG. 3, in an embodiment, the laser devices 10 in the first laser group and the laser devices 10 in the second laser group are alternately provided along the conveying direction of the pole sheet 11. A conveying apparatus may be formed by a combination of an unwinding apparatus 12, a winding apparatus 16 and a driven roller 13, and the conveying apparatus is configured to convey the pole sheet 11. The following is an example of the alternating arrangement of the laser devices 10 in the first laser group and the laser devices 10 in the second laser group. The first laser group may have four laser devices 10, which are respectively named as the first laser device 100, the second laser device 300, the third laser device 500 and the fourth laser device 700. The second laser group may also have four laser devices 10, which are respectively named as the fifth laser device 200, the sixth laser device 400, the seventh laser device 600 and the eighth laser device 800. Along the conveying direction of the pole sheet 11, the laser devices 10 in the first laser group and the laser devices 10 in the second laser group are distributed as follows: the first laser device 100, the fifth laser device 200, the second laser device 300, the sixth laser device 400, the third laser device 500, the seventh laser device 600, the fourth laser device 700 and the eighth laser device 800. When the pole sheet 11 is slotted, the first laser device 100, the second laser device 300, the third laser device 500 and the fourth laser device 700 are all turned on to slot the pole sheet 11, while the fifth laser device 200, the sixth laser device 400, the seventh laser device 600 and the eighth laser device 800 are all turned off. When the temperature of the galvanometer and the field lens in the first laser device 100, the second laser device 300, the third laser device 500 and the fourth laser device 700 is too high, the first laser device 100, the second laser device 300, the third laser device 500 and the fourth laser device 700 are turned off. At the same time, the fifth laser device 200, the sixth laser device 400, the seventh laser device 600 and the eighth laser device 800 are turned on to continue processing the pole sheet 11. When the temperature of the galvanometer and the field lens in the fifth laser device 200, the sixth laser device 400, the seventh laser device 600 and the eighth laser device 800 is too high, the fifth laser device 200, the sixth laser device 400, the seventh laser device 600 and the eighth laser device 800 are turned off. At the same time, the first laser device 100, the second laser device 300, the third laser device 500 and the fourth laser device 700 are turned on to continue processing the pole sheet 11. The cycle is repeated until the processing of the pole sheet 11 is completed.

When the temperature value of any one of the galvanometer and field lens of the laser device 10 in the first laser group reaches the set value, the laser device 10 in the first laser group will be turned off. In this way, the temperature of the galvanometer or field lens can be prevented from being too high, causing damage, thereby causing the processing quality of the pole sheet 11 to be low. When the laser device 10 in the first laser group is turned off, the laser device 10 in the second laser group continues to process the pole sheet 11. The first laser group can be quickly put into the processing of the pole sheet 11 by cooling the galvanometer or field lens. In an embodiment, in step S2, the method for using the laser device also includes the step of cooling the galvanometer and field lens of the laser device 10 in the first laser group after turning off the laser device 10 of the first laser group. In addition, after cooling the galvanometer and field lens of the laser device 10 in the first laser group, on the one hand, the first laser group can be quickly put into the processing of the pole sheet 11, and on the other hand, the galvanometer and field lens of the laser device 10 in the first laser group can be effectively prevented from being damaged under high temperature conditions.

In an embodiment, the galvanometer and the field lens are cooled by water cooling or air cooling. The method of cooling the galvanometer by water cooling may be to reduce the temperature of the galvanometer by indirect contact between the liquid and the galvanometer. The method of cooling the field lens by water cooling may be to reduce the temperature of the field lens by indirect contact between the liquid and the field lens. The method of cooling the galvanometer by air cooling may be to set a ventilation channel so that the air passes through and indirectly contacts the galvanometer, thereby reducing the temperature of the galvanometer. The method of cooling the galvanometer by air cooling may be to set a ventilation channel so that the air passes through and indirectly contacts the field lens, thereby reducing the temperature of the field lens.

When the temperature value of any one of the galvanometer and field lens of the laser device 10 in the second laser group reaches the set value, the laser device 10 in the second laser group will be turned off. In this way, the temperature of the galvanometer or field lens can be prevented from being too high, causing damage, thereby causing low processing quality of the pole sheet 11. When the laser device 10 in the second laser group is turned off, the laser device 10 in the first laser group continues to process the pole sheet 11. The second laser group can be quickly put into the processing of the pole sheet 11 by cooling the galvanometer or field lens. In an embodiment, in step S3, the method for using the laser device also includes the step of cooling the galvanometer and field lens of the laser device 10 in the second laser group after turning off the laser device 10 of the second laser group. In addition, after the galvanometer and field lens of the laser device 10 in the second laser group are cooled, on the one hand, the second laser group can be quickly put into the processing of the pole sheet 11, and on the other hand, the galvanometer and field lens of the laser device 10 in the second laser group can be effectively prevented from being damaged under high temperature conditions.

When the laser device 10 in the first laser group processes the pole sheet 11, the galvanometer and the field lens of the laser device 10 in the first laser group are cooled down at the same time. In an embodiment, in step S1, when the laser device 10 in the first laser group is turned on and configured to process the pole sheet 11, the galvanometer and the field lens of the laser device 10 in the first laser group are cooled down at the same time. In this way, when the laser device 10 is working, cooling down the galvanometer and the field lens of the laser device 10 in the first laser group can effectively prevent the galvanometer and the field lens from heating up too quickly, and prevent the galvanometer and the field lens from being damaged due to excessively high temperatures.

Similarly, when the laser device 10 in the second laser group processes the pole sheet 11, the galvanometer and the field lens of the laser device 10 in the second laser group can be cooled down at the same time. In an embodiment, in step S2, when the laser device 10 in the second laser group is turned on and configured to the process the pole sheet 11, the galvanometer and the field lens of the laser device 10 in the second laser group are cooled down at the same time. In this way, when the laser device 10 is working, cooling down the galvanometer and the field lens of the laser device 10 in the second laser group can effectively prevent the galvanometer and the field lens from heating up too quickly, and prevent the galvanometer and the field lens from being damaged due to excessive temperature.

The structure of the production line 9 is introduced below, as shown in FIG. 3. The production line 9 is mainly used to process the pole sheet 11. The production line 9 includes an unwinding apparatus 12, a driven roller 13, a dust cleaning apparatus 14, a tension apparatus 15, a laser device 10 and a winding apparatus 16, which are provided in sequence along the conveying direction of the pole sheet 11. The function of the unwinding apparatus 12 is to unwind the material, and the driven roller 13 cooperates with various apparatuses to realize the conveying of the pole sheet 11. The function of the dust cleaning apparatus 14 is to clean the incoming material and the dust before winding. The dust cleaning apparatus 14 includes a brush, a wind knife, an ion wind and an ultrasonic dust cleaning etc. The function of the tension apparatus 15 is to realize tension control to ensure that the material strip of the pole sheet 11 is tensioned. The laser device 10 is mainly used to process the pole sheet 11.

In an embodiment, the production line 9 includes: a first laser group, a second laser group, a temperature sensor and a controller. The first laser group and the second laser group each include a plurality of laser devices 10, and the laser devices 10 are configured to process the pole sheet 11. The temperature sensor is configured to detect the temperature value of the galvanometer and the field lens in the laser device 10. The controller is connected to the first laser group, the second laser group and the temperature sensor, and the controller is configured to receive and send signals.

The controller is configured to: in response to detecting that any temperature value of the galvanometer and the field lens in the first laser group reaches a set value, turn off the laser device 10 in the first laser group and turn on the laser device 10 in the second laser group. And in response to detecting that any temperature value of the galvanometer and the field lens in the second laser group reaches a set value, turn off the laser device 10 in the second laser group and turn on the laser device 10 in the first laser group.

The first laser group includes a plurality of laser devices 10, and the second laser group includes a plurality of laser devices 10. The pole sheet 11 is processed by the laser devices 10 in the first laser group, such as slotting the pole sheet 11. Afterwards, the temperature value of the galvanometer and the field lens of the laser device 10 in the first laser group is detected by the temperature sensor. When the temperature sensor detects that any temperature value of the galvanometer or the field lens of the laser device 10 in the first laser group reaches the set value, the temperature sensor sends a signal to the controller, and the controller is configured to turn off the laser device 10 in the first laser group, which can protect the galvanometer and the field lens of the laser device 10 in the first laser group and prevent the processing quality of the pole sheet 11 by the galvanometer and the field lens from being reduced. At the same time, the controller is configured to turn on the laser device 10 in the second laser group to continue processing the pole sheet 11. The pole sheet 11 can be processed uninterruptedly to improve production efficiency. When the temperature sensor detects that any temperature value of the galvanometer or field lens of the laser device 10 in the second laser group reaches the set value, the temperature sensor sends a signal to the controller, and the controller is configured to turn off the laser device 10 in the second laser group, which can protect the galvanometer and field lens of the laser device 10 in the second laser group, and prevent the galvanometer and field lens from reducing the processing quality of the pole sheet 11. At the same time, the controller is configured to turn on the laser device 10 in the first laser group to continue processing the pole sheet 11, which can process the pole sheet 11 uninterruptedly to improve production efficiency. In this way, the pole sheet 11 can be processed uninterruptedly by switching the laser devices 10 in the first laser group and the second laser group, which can make the production line 9 have a higher production efficiency. The method for using the laser device can ensure that the laser device 10 has a high slotting quality for the pole sheet 11, and can also make the production line 9 have a high production efficiency.

The controller is a feedback loop component widely used in industrial control applications, such as a programmable memory or a single-chip microcomputer. It controls various types of mechanical equipment or production processes through digital or analog input and output by storing instructions for performing operations such as logical operations, sequential control, timing, counting and arithmetic operations internally. It can be seen that the controller can be configured to send instructions to turn the laser device 10 on and off, and the controller can also be configured to receive the temperature value detected by the temperature sensor to make instructions. In this application, the controller can realize the alternating use of the laser device 10 in the first laser group and the second laser group. Those skilled in the art can realize it according to the existing controller function. The principle and control method of the controller belong to the related art and are not described in detail here.

In an embodiment, the laser device 10 includes a first cooling member, the first cooling member is thermally connected to the galvanometer. The first cooling member is provided with a first cooling channel, and the first cooling channel is configured for the flow of cooling medium. The cooling medium can be a liquid or a gas, and a fast cooling material, such as ice cubes, can be added to the liquid. The cooling medium flows in the first cooling channel and can take away the heat of the galvanometer, thereby cooling the galvanometer. This can ensure that the galvanometer keeps working and can effectively prevent the galvanometer from being damaged due to excessive temperature.

In an embodiment, the laser device 10 includes a second cooling member, the second cooling member is thermally connected to the field lens, and the second cooling member is provided with a second cooling channel, and the second cooling member is configured for the flow of cooling medium. The cooling medium can be a liquid or a gas, and a fast cooling material, such as ice cubes, can be added to the liquid. As the cooling medium flows in the second cooling channel and can take away the heat of the field lens, thereby cooling the field lens. This can ensure that the field lens keeps working and can effectively prevent the field lens from being damaged due to excessive temperature.

As shown in FIG. 3, in an embodiment, the production line 9 also includes a conveying apparatus, which is configured to convey the pole sheet 11. Along the conveying direction of the pole sheet 11, the laser device 10 in the first laser group and the laser device 10 in the second laser group are alternately provided. The conveying apparatus can be formed by a combination of the unwinding apparatus 12, the winding apparatus 16 and the driven roller 13, and the conveying apparatus is configured to convey the pole sheet 11. The following is an example of the alternating arrangement of the laser device 10 in the first laser group and the laser device 10 in the second laser group. The first laser group may have four laser devices 10, which are respectively named as the first laser device 100, the second laser device 300, the third laser device 500 and the fourth laser device 700. The second laser group may have four laser devices 10, which are respectively named as the fifth laser device 200, the sixth laser device 400, the seventh laser device 600 and the eighth laser device 800. Along the conveying direction of the pole sheet 11, the laser devices 10 in the first laser group and the laser devices 10 in the second laser group are distributed as follows: the first laser device 100, the fifth laser device 200, the second laser device 300, the sixth laser device 400, the third laser device 500, the seventh laser device 600, the fourth laser device 700 and the eighth laser device 800. The laser devices 10 in the first laser group can process the front side of the pole sheet 11, and the laser devices 10 in the second laser group can process the back side of the pole sheet 11. That is, the first laser device 100, the second laser device 300, the third laser device 500 and the fourth laser device 700 process the front side of the pole sheet 11, and the fifth laser device 200, the sixth laser device 400, the seventh laser device 600 and the eighth laser device 800 process the back side of the pole sheet 11. In addition, among the eight laser devices 10, the first four laser devices 10 process the front side of the pole sheet 11, and the last four laser devices 10 process the back side of the pole sheet 11. That is, the first laser device 100, the fifth laser device 200, the second laser device 300 and the sixth laser device 400 process the front side of the pole sheet 11, and the third laser device 500, the seventh laser device 600, the fourth laser device 700 and the eighth laser device 800 process the back side of the pole sheet 11.

The embodiments of the present application are described in detail above in conjunction with the drawings, but the present application is not limited to the above embodiments. Various changes can be made within the knowledge of those skilled in the art without departing from the purpose of the present application. In addition, the embodiments of the present application and the features in the embodiments can be combined with each other without conflict.

What is claimed is:

1. A method for using a laser device, the laser device being applied to a production line, the production line comprising a plurality of laser devices, and the laser device being configured to process a pole sheet; the method comprising following steps:
S1, dividing the plurality of laser devices into a first laser group and a second laser group, and turning on the laser device in the first laser group and processing the pole sheet;
S2, in response to that any temperature value of a galvanometer and a field lens of the laser device in the first laser group reaches a set value, turning off the laser device in the first laser group, and turning on the laser device in the second laser group to continue processing the pole sheet;
S3, in response to that any temperature value of the galvanometer and field lens of the laser device in the second laser group reaches the set value, turning off the laser device in the second laser group, and turning on the laser device in the first laser group to continue processing the pole sheet; and
S4, repeating steps S2 to S3.

2. The method of claim 1, wherein in step S2, the method further comprises the following step:
after turning off the laser device of the first laser group, cooling down the galvanometer and the field lens of the laser device in the first laser group.

3. The method of claim 2, wherein the galvanometer and the field lens are cooled by water cooling or air cooling.

4. The method of claim 1, wherein in step S3, the method further comprises the following step:
after turning off the laser device of the second laser group, cooling down the galvanometer and the field lens of the laser device in the second laser group.

5. The method of claim 1, wherein in step S1, when the laser device in the first laser group is turned on and configured to process the pole sheet, the galvanometer and the field lens of the laser device in the first laser group are cooled down at the same time.

6. The method of claim 1, wherein in step S2, when the laser device in the second laser group is turned on and configured to process the pole sheet, the galvanometer and the field lens of the laser device in the second laser group are cooled down at the same time.

7. A production line, comprising:
a first laser group;
a second laser group;
a temperature sensor; and
a controller, wherein:
the first laser group and the second laser group each comprise a plurality of laser devices, and the laser devices are configured to process a pole sheet;
the temperature sensor is configured to detect a temperature value of a galvanometer and a field lens in the laser device;
the controller is connected to the first laser group, the second laser group and the temperature sensor, and the controller is configured to receive and send signals; the controller is configured to:
in response to detecting that any temperature value of the galvanometer and the field lens in the first laser group reaches a set value, turn off the laser device in the first laser group and turn on the laser device in the second laser group; and in response to detecting that any temperature value of the galvanometer and the field lens in the second laser group reaches the set value, turn off the laser device in the second laser group and turn on the laser device in the first laser group.

8. The production line of claim 7, wherein the laser device comprises a first cooling member, the first cooling member is thermally connected to the galvanometer; the first cooling member is provided with a first cooling channel, and the first cooling channel is configured for the flow of cooling medium.

9. The production line of claim 7, wherein the laser device comprises a second cooling member, the second cooling member is thermally connected to the galvanometer; the second cooling member is provided with a second cooling channel, and the second cooling channel is configured for the flow of cooling medium.

10. The production line of claim 7, further comprising:
a conveying apparatus,
wherein the conveying apparatus is configured to convey the pole sheet, and the laser device in the first laser group and the laser device in the second laser group are alternately provided along a conveying direction of the pole sheet.
